(19) United States
(12) Patent Application Publication
(10) Pub. No.: US 2012/0144645 A1
(43) Pub. Date: Jun. 14, 2012

(54) FITTING INSERTION APPARATUS AND METHOD

(76) Inventor: Patrick Boucher, Milford, NH (US)

(21) Appl. No.: 13/044,104

(22) Filed: Mar. 9, 2011

Related U.S. Application Data
(60) Provisional application No. 61/313,013, filed on Mar. 11, 2010.
(60) Provisional application No. 61/311,898, filed on Mar. 9, 2010.

(51) Int. Cl. B23P 11/00; B23P 19/00

(52) U.S. Cl. 29/428; 29/700

(57) ABSTRACT

A tube fitting insertion tool comprising a mounting plate, a pusher element attached to the mounting plate, supporting a fitting and defining a pusher axis, a clamp attached to the mounting plate and defining a clamp axis, and a tube holder arranged at the intersection of the pusher and clamp axis, with at least one tube channel for supporting a portion of a tube.

### CROSS REFERENCE TO RELATED APPLICATIONS

This application claims benefit from U.S. Provisional Patent Application Ser. No. 61/311,898 filed Mar. 9, 2010 and U.S. Provisional Patent Application Ser. No. 61/313,013 filed Mar. 11, 2010.

### FIELD OF THE INVENTION

The present invention relates to securing a fitting on the end of a tube and, more particularly, to a portable machine and method for quickly, reliably and effectively inserting a fitting into an open end of a tube, such as medical tubing.

### BACKGROUND OF THE INVENTION

The current method of assembling a fitting to an end of a medical tube is primarily preformed by hand. The method involves a person grasping a medical tube, adjacent a terminal end thereof, with a first hand and grasping a medical tube fitting with a second hand. The terminal end of the medical tube is typically prepared by first dipping the same into a suitably conventional solution to soften and/or lubricate the end to be inserted. The person then inserts the desired fitting into the terminal end of the medical tube, typically rotating the fitting in clockwise and/or counter clockwise directions as needed, until the leading end of the fitting is suitably inserted to a predetermined length into the end of the medical tube. This is a process that is very taxing on the hands and fingers of the person especially when preformed many hundred times a day.

As is also known in the art, spreaders have been used to temporarily increase the diameter of the terminal end of the medically tube and thereby facilitate insertion of a fitting therein.

### SUMMARY OF THE INVENTION

Wherefore, it is an objective of the present invention to overcome the above mentioned shortcomings and drawbacks with the associated prior art and increase and improve the efficiency and reliably of inserting a fitting into an open end of a tube, such as medical tubing.

A further object of the present invention further relates to an inexpensive, quick, accurate, mobile, low taxing mechanism for inserting a desired one of a plurality of different fittings into a desired one of a plurality of different sized tubes.

Another object of the present invention relates to an apparatus and method which may be completely operated manually, thereby providing the device exceptional mobility at a low cost.

The following description of a specific embodiment of the presently claimed invention will demonstrate some of the aspects of the presently claimed invention. The fitting insertion tool generally comprises a pusher element, a clamp and a tube holder, all attached to and supported by a base plate. The pusher element may be attached through a pusher base to the base plate with two 10-24 carriage bolts, for example, and two 10-24 thumb nuts, for example. The pusher element base can move approximately 5″ left to right to accommodate various shapes, length and/or sizes of fittings. The pusher element may have a Push/Pull Action Toggle Clamp. The base plate can have a fitting holder block used for keeping various types of fitting holders used while inserting fittings into tubing.

The clamp may have a Hold Down Toggle Clamp attached to a clamp base. The clamp base is stationarily secured to one (e.g., a left) side of the base plate and held by two 8-32 screws on the bottom side, and the toggle clamp is held by four 10-32 screws. Left center on base plate is the tube holder, upon which a tube is placed. The tube holder base into also stationary and is held in place with two 8-32 screws. The tube channel block portion of the tube holder can hold four different size tubes ranging from ⅛″ to ¼″ and is rotated for each size tube. The tube holder is attached to the clamp base using with a 10-24 shoulder bolt and compression spring. Additional tube holders can been designed for up to 1″ tubing. The arrangement of the components of the fitting insertion tool can be generally flipped from one side to another for left hand operators.

The fitting insertion tool allows for fittings and tubing to mate properly with no pressure or vacuum leaks after the insertion of mating parts is complete. Fitting holders are designed for specific types of fittings depending the size of the fitting openings, if they are male or female ends, and if they are straight barb or elbow type fittings. For each variation of fitting design, the fitting holder will vary according to the fitting style.

The clamp holds the tube in place to prevent the tubing from moving while a fitting is being inserting therein. The fitting insertion tool holds and moves fittings for insertion into tubes, and is adjustable left to right depending on size of barb fitting. The tube holder base is in fixed position, but the tube channel block can rotate depending on size of tube. The tube channel block is held with a shoulder bolt and compression spring to allow rotation of the block for various size tubes.

A tube is held in fixed position on the tube holder, while the fitting insertion tool holds the fitting on a center line piercing each the center of the tube and the center of the fitting. This alignment allows for the proper insertion of fittings into tubes with little effort.

The fitting holders are made for specific types of fittings. One end may have o-ring type and other end non o-ring fitting with various size barb. Holder for elbows can hold same size elbow with different size barb.

The tube holders may be pinned, to allow for the interchange of multiple tube holders. The various components of the fitting insertion tool may be made out of metallic, plastic, and/or rubber, such as aluminum and polyvinylchloride. Fitting holder nubs, upon which fittings are loaded, will normally be 2-3 thousandths of an inch less than the interior diameter of the through bore of the female fittings or 2-3 thousandths of an inch larger than the exterior diameter of the male fittings.

It is to be appreciated that many variations and/or modifications may be made to the above embodiment while still encompassing the inventive aspects of the presently claimed invention.

### BRIEF DESCRIPTION OF THE DRAWINGS

The invention will now be described, by way of example, with reference to the accompanying drawings in which:

FIG. 1 is a diagrammatic top plan view of the fitting insertion tool;

FIG. 2 is a diagrammatic side elevational view of the fitting insertion tool;

FIG. 3 is a diagrammatic side elevational view of the pusher element of FIGS. 1 and 2 shown in a retracted position;

FIG. 4 is a diagrammatic side elevational view of the pusher element of FIGS. 1 and 2 shown in an extended position;

FIG. 5 is a diagrammatic end elevational view of the clamp and tube holder of FIGS. 1 and 2, with the clamp shown in a loading position;

FIG. 6 is a diagrammatic end elevational view of the clamp and tube holder of FIGS. 1 and 2, with the clamp shown in a locked position;

FIG. 7 is a diagrammatic end elevational view of the tube holder of the fitting insertion tool;

FIG. 8 is a diagrammatic end elevational view of the tube channel block of the fitting insertion tool;

FIGS. 9A-9C are diagrammatic top plan views of tube channel block adapted to fit “Y” shaped couplings;

FIG. 10 is a diagrammatic side elevational view of a two sided fitting holder of the fitting insertion tool;

FIG. 11 is an exploded diagrammatic side elevational view of a one sided fitting holder of the fitting insertion tool and a fitting;

FIG. 12 is a diagrammatic side elevational view of a fitting holder of the fitting insertion tool for holding an elbow shaped fitting;

FIGS. 13 is a diagrammatic top plan view of the fitting holder of the fitting insertion tool of FIG. 12;

FIG. 14 is a diagrammatic isometric representation of a tube channel block of the fitting insertion tool;

FIG. 15 is a diagrammatic isometric representation of the tube holder of the fitting insertion tool;

FIG. 16A is diagrammatic top plan view of the tube holder of the fitting insertion tool in a secured position; and

FIG. 16B is diagrammatic top plan view of the tube holder of the fitting insertion tool in a rotatable position.

### DETAILED DESCRIPTION OF THE INVENTION

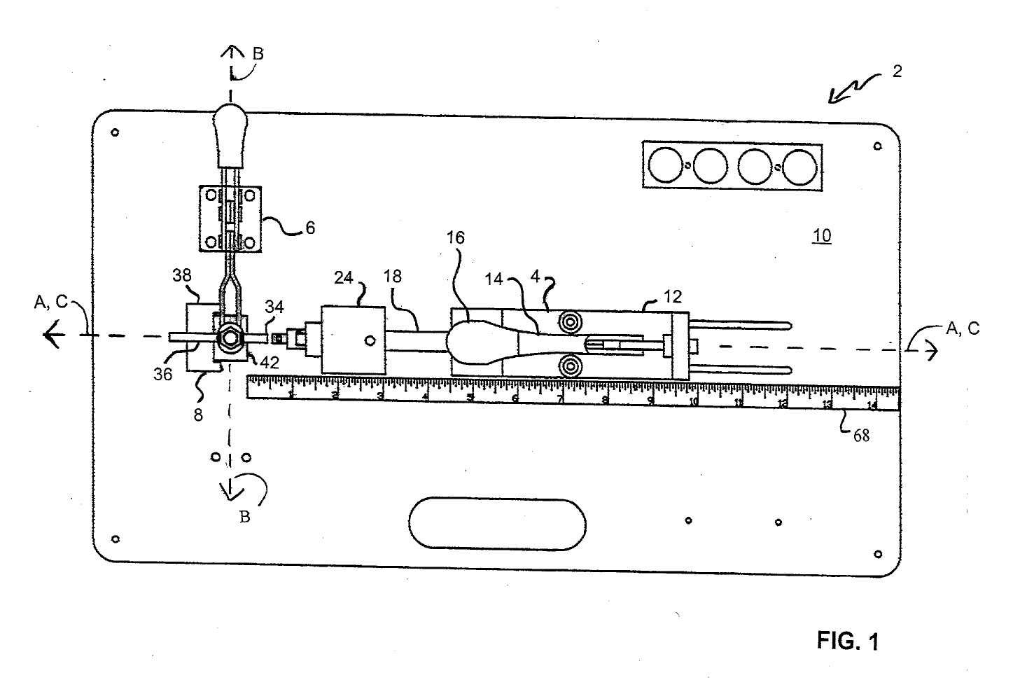

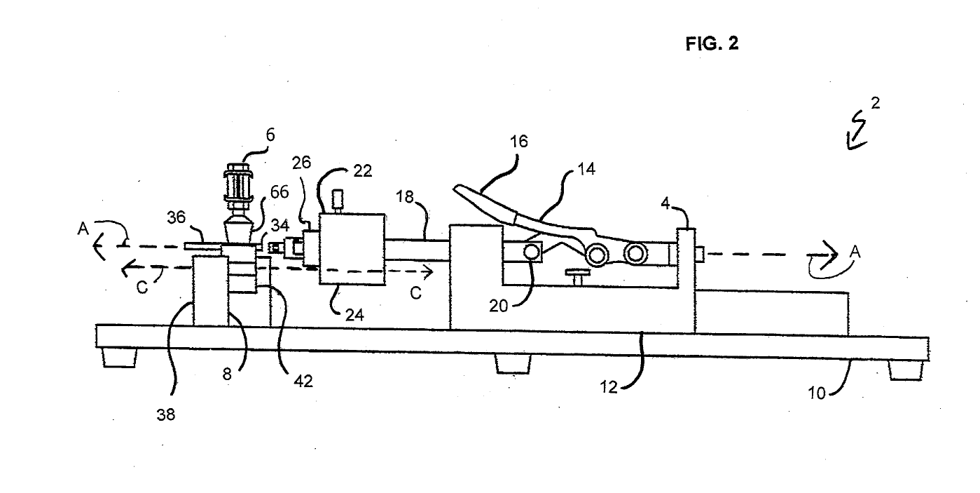

As can be seen from FIGS. 1 and 2, the tube fitting insertion tool 2 generally comprises a pusher element 4, a clamp 6 and a tube holder 8, which are all fixedly attached to a top surface of a mounting plate 10. Each component of the tube fitting insertion tool 2 will now be described below in further detail.

In the embodiment shown in FIGS. 1 and 2, the pusher element 4 defines a pusher axis A while the clamp 6 generally defines a clamp axis B with the clamp axis B preferably being aligned at a right angle to the pusher axis A. The tube holder 8 is generally located at an intersection of the pusher axis A with the clamp axis B.

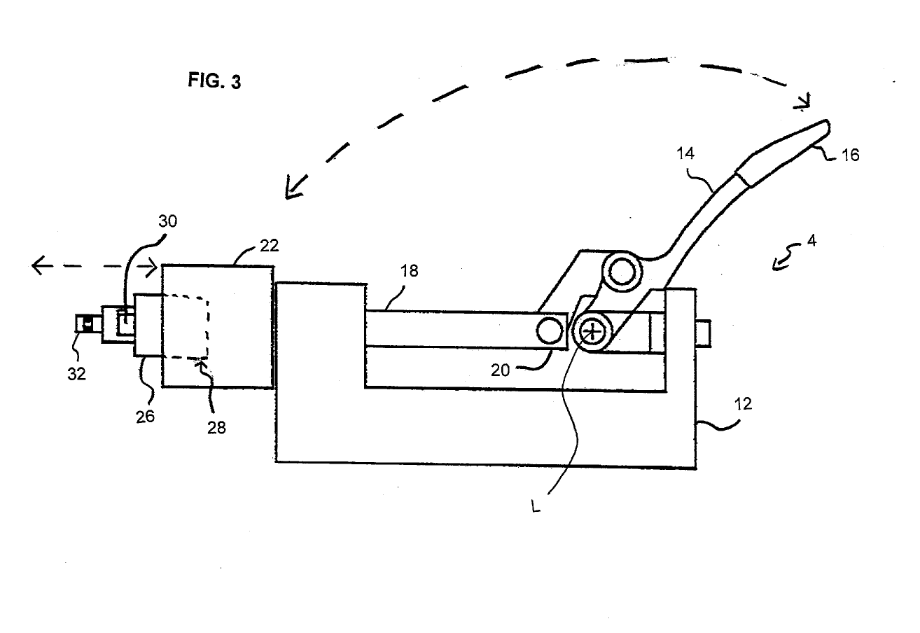

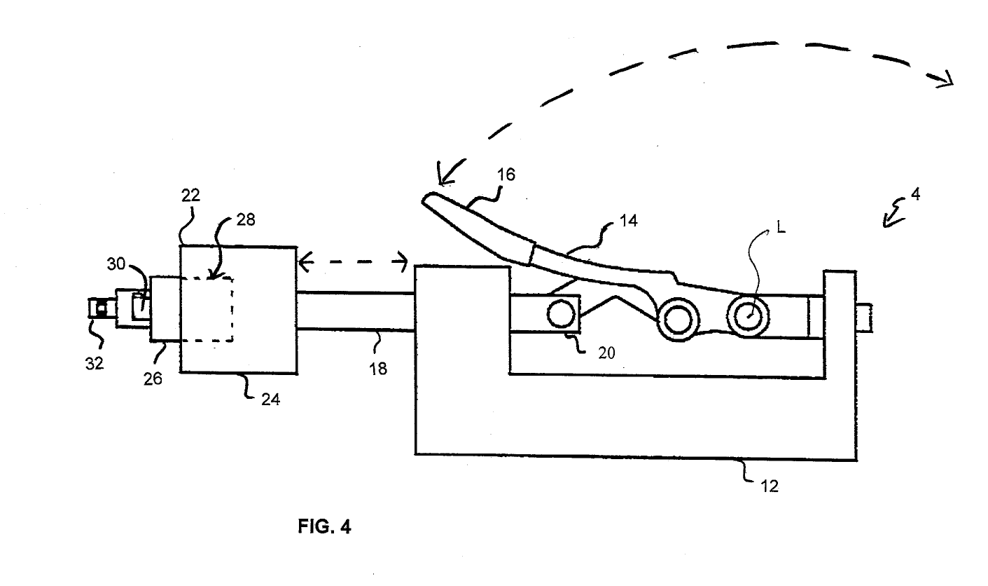

As shown in FIGS. 1, 2, 3, and 4, the pusher element 4 comprises a pusher base 12, which is directly mounted to the mounting plate 10, by one or more conventional fasteners, and supports a lever 14, which is pivotably coupled to a shaft 18 by a conventional linkage (not separately labelled). A conventional hand grip 16 is secured to and covers the remote end of the lever 14 and this hand grip 16 facilitates an operator gripping and exerting a desired insertion/retraction force on the lever 14 to cause the lever 14 to rotate about its pivot axis L from a retracted position, shown in FIG. 3, into the extended position, shown in FIG. 4. The shaft 18 includes a first end 20 and an opposed second end 22 with the second end passing through a shaft aperture formed in the pusher base 12. If desired, a bearing or some other conventional low friction guide component or member may be located within the shaft aperture to facilitate the sliding to and fro motion of the shaft 18, with respect to the pusher base 12, along the pusher axis A. As briefly noted above, the lever 14 and its conventional linkage interconnect the pusher base 12 with the first end 20 of the shaft 18 so as that as the lever 14 is pivoted about its pivot axis L, the lever 14 exerts an axial prying force on the shaft 18 which forces the shaft 18 to move to and fro along the pusher axis A, depending upon the direction in which the lever 14 is pivoted.

The second end 22 of the shaft 18 supports a holder seat 24 and the holder seat 24 has a cavity 28 which supports a fitting holder 26. The cavity 28 is centred with respect to the pusher axis A. The fitting holder 26 is slidably received within and retained by the cavity 28 of the holder seat 24. A set screw, for example (not shown), is utilized for releasably retaining the fitting holder 26 within the cavity 28 of the holder seat 24. It is to be appreciated that a variety of other conventional and well known mechanisms could be utilized for releasably securing the fitting holder 26 within the cavity 28. A forward or leading end of the fitting holder 26 has a cylindrical shaped protrusion or nub 30 which is sized and shaped so as to be slidably received within a centrally located through bore of a fitting 32 and temporarily secure and support the desired fitting 32 thereon. Preferably the nub 30 is sized to releasably retain the fitting 32 thereon, e.g., the nub is between 1 to 5 thousandths of an inch less than the diameter of the through bore of the fitting 32, so that the fitting 32 is precisely aligned with the pusher axis A while still allowing the fitting 32 to be easily removed therefrom once engaged with the terminal end 34 of the tube 36, as described below in further detail. If desired, a plurality of fitting holders 26 may be used with each having different sized nubs 30 for matingly engaging with different size through bores in a trailing end of the fittings 32 or, alternatively, the fitting holder 26 may be reversible and have a different sized nub 30 on a second opposite end thereof. A further detail discussion concerning the purpose and function of the fitting holder 26 will follow below. In view of the above discussion, it will be appreciated that when the lever 14 is actuated, i.e., moved from its retracted position, shown in FIG. 3, into the extended position, shown in FIG. 4, the fitting holder 26 is caused to slide or move the fitting 32, temporarily supported by the nub 30, along the pusher axis A toward the aligned terminal end 34 of the tube 36 which is temporarily retained by the tube holder 8, and a further detail discussion concerning the same will follow below.

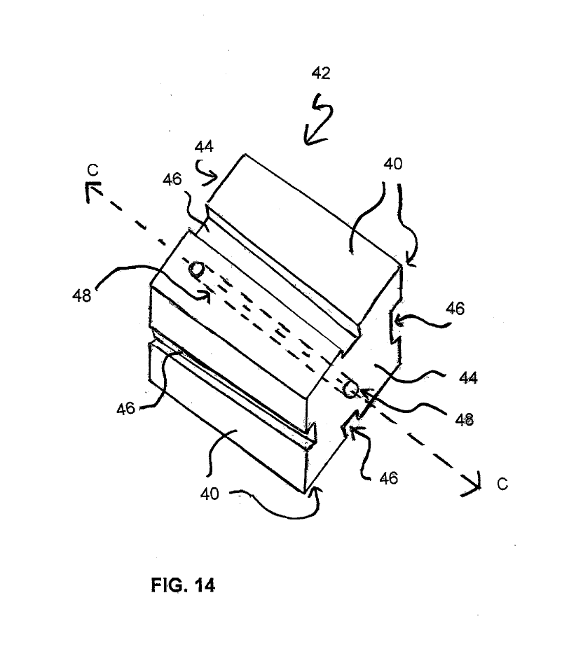

The tube holder 8 comprises a tube holder base 38 which is directly mounted to the mounting plate 10, by one or more conventional fasteners, and supports a removal tube channel block 42. In the embodiment shown in FIGS. 1, 2, 14, 15, 16A and 16B, the tube channel block 42 generally has two opposed end surfaces 44 and four lateral exterior surfaces 40. Each lateral exterior surface 40 has a tube channel 46 formed therein. As shown in 1, 2, 14, 15, 16A and 16B, the tube holder base 38 supports a needle shaft 48, which defines a mounting axis C, and a spring 49 while the tube channel block 42 has a centrally located shaft aperture within which the needle shaft 48 is received. The mounting axis C (as can be seen in FIG. 2) extends parallel to the pusher axis A but is located closer to the mounting plate 10 than the pusher axis A. The spring 49 biases the tube channel block 42 along the needle shaft 48 toward and against the tube holder base 38, so as to retain the tube channel block 42 within a stationary position. When the operator desires to select another one of the tube channels 46, formed within one of the lateral exterior surfaces 40 of the tube channel block 42, the operator grasps the tube channel block 42 and pulls the tube channel block 42 away from the tube holder base 38, thereby sliding the tube channel block 42 along the needle shaft 48 and compressing the spring.

Each one of the tube channels 46 preferably has a different size so as to facilitate accommodating a different size outer diameter tube 36 therein, e.g., the width of each one of the tube channels may incrementally increase in size by increments of, for example, 1/32, 1/16, ⅛, ¼ of an inch, etc. Each tube channel 46 extends the entire length of the exterior surface 40 of the tube channel block 42 to facilitate receiving a tube therein. Each one of tube channels 46 typically has a width which is generally equal to the width of the tube 36 to be accommodated therein while depth of the respective tube channel is generally equal to approximately 80% of the diameter of the tube 36 that is designed to be accommodated and held within that particular tube channel 46 (see FIG. 8 for example), such that a small portion of the tube 36 will protrude from the tube channel 46 and facilitate clamping by the clamp 6. The present invention is suitable for use with tubes typically ranging from between about 1/16 inch to about 1 inch in diameter, and more preferably between 3/32 of an inch and ½ of an inch in diameter, and most preferably between about ⅛ of an inch and ¼ of an inch in diameter. It is to be appreciated that the tube channel block 42 can be varied so as to accommodate virtually any desired size tube.

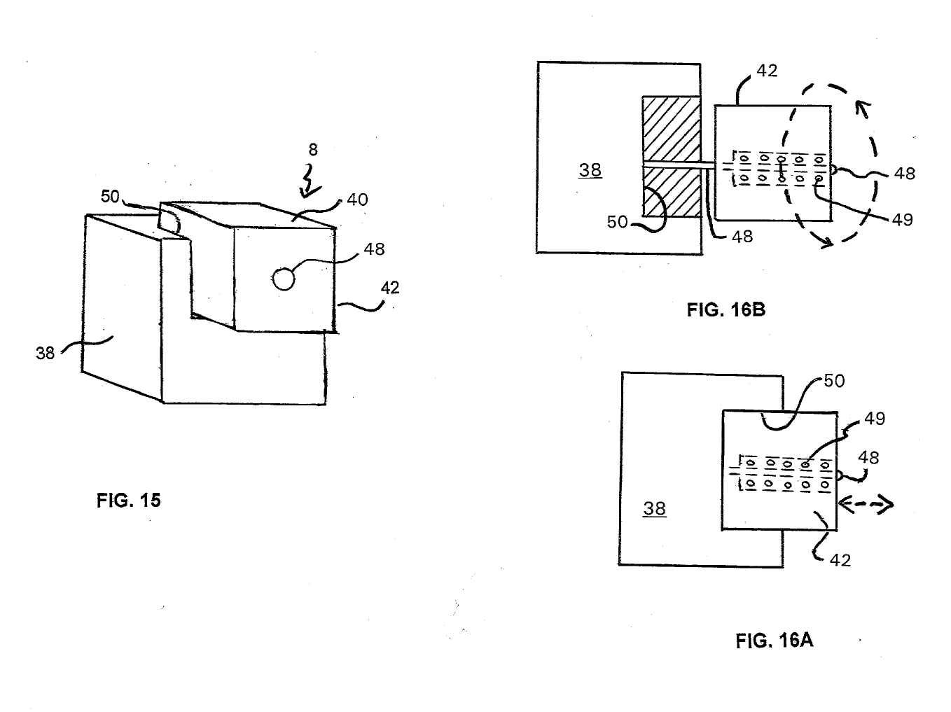

Turning now to FIGS. 15, 16A and 16 B, it can be seen that the tube holder base 38 includes a recessed portion 50 that is preferably shaped and sized so as to accommodate and seat one end of the tube channel block 42 within the recessed portion 50 while the opposite end of the tube channel block 42 is permitted to protrude slightly from the tube holder base 38, as shown in FIGS. 1 and 2. Such arrangement facilitates secure seating of the tube channel block 42 while still exposing one of the tube channels 46 which is aligned with the pusher axis A and can accommodate a desired size tube 36 therein. During use, the tube 36 is placed within and accommodated by the tube channel 46 such that a center 52 of the terminal end 34 of the tube 36 is precisely aligned with the pusher axis A and thus also precisely aligned with the desired fitting 32 which is supported by the nub 30 and which is to be installed within the through bore formed in the terminal end 34 of the tube 36.

In the event that the terminal end 34 of the desired tube 36 can not be suitably accommodated within the tube channel 46 (as shown in FIG. 8 for example) that is currently aligned along the pusher axis A, then the tube channel block 42 is biassed axially along the needle shaft 48 toward the pusher element 4 (i.e., along the mounting axis C) thereby compressing the spring 49 until the tube channel block 42 is completely removed from the recessed portion 50 of the tube holder base 38. Once the tube channel block 42 is so located, the tube channel block 42 is rotatable, as shown in FIG. 16B, and can be rotated about needle shaft 48 until an appropriately sized tube channel 46 is suitably aligned with the pusher axis A. That is, the tube channel block 42 is rotated about the needle shaft 48 until the desired sized tube channel 46 is coincident with the pusher axis A. Finally, the operator releases the tube channel block 42 and the tube channel block 42 is then allowed to be biassed back into the recessed portion 50 by the spring 49 and assume the position shown in FIGS. 15 and 16A.

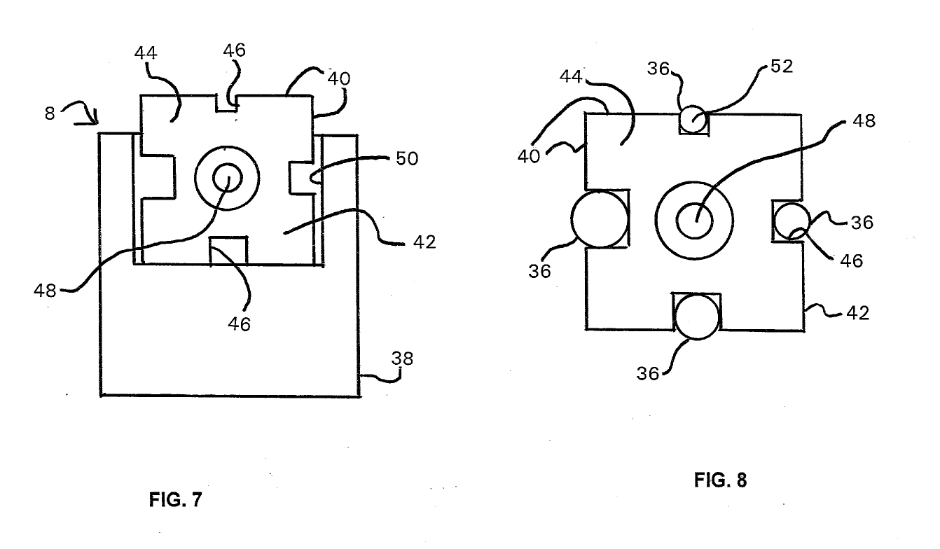

While the transverse cross sectional profile of the tube channel block 42 is shown as being square in FIGS. 7, 8, 14, 15, 16A and 16 B, it is to be appreciated that the transverse cross-sectional profile of the tube channel block 42 may have the shape of a circle, a triangle, or other regular polygons including a pentagon, a hexagon, an octagon, etc., with each one of the exterior surfaces of the polygon accommodating a tube channel 46. In such embodiments, the number of exterior surfaces 40 may be 3, 5, 6, 8, or some other value, corresponding to the number of sides in the regular polygon. In such alternative embodiments, the recessed portion 50 of the tube holder base 38 will be correspondingly shaped such that at least one exterior surface 40 will rest or about against the least one surface of the recessed portion 50, and at least one exterior surface 40, with a tube channel 46 formed therein, will be aligned along the pusher axis A and positioned so as to receive a tube 36 and be clamped by the clamp 6. In the case where the lateral surfaces 40 are in the shape of a circle, the number of exterior sides will equal 1, and that same one side will be both in contact with the recess portion 50 and have at least one tube channel 46 exposed.

In an additional alternative embodiment, not shown, multiple tube channels 46 may be located parallel to one another on the same exterior surface 40 of the tube channel block 42. In one such embodiment, either the tube holder base 38 and/or the tube channel block 42 will be lockably slidable generally perpendicular to the pusher axis A. In this embodiment, in a first lockably slidable position a center 48 of a first tube 36 arranged on a first tube channel 46 will be aligned with the pusher axis A, while in a second lockably slidable position, a center 48 of a second tube 36 arranged on a second tube channel 46 will be aligned with the pusher axis A. In this embodiment, each additional tube channel 46, provided in or on each exterior surface 40, will correspond to an additional lockably slidable position of the tube holder base 38 and/or the tube channel block 42.

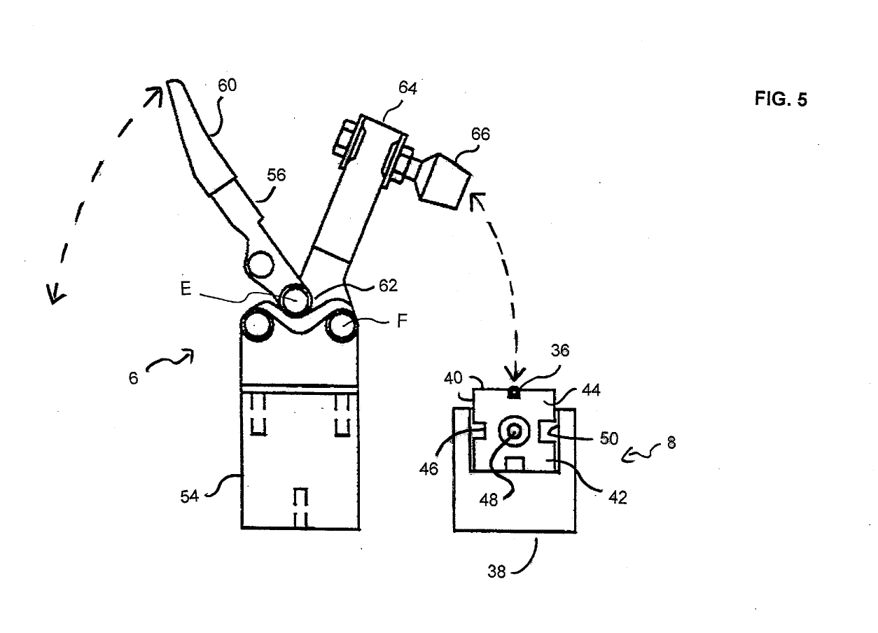

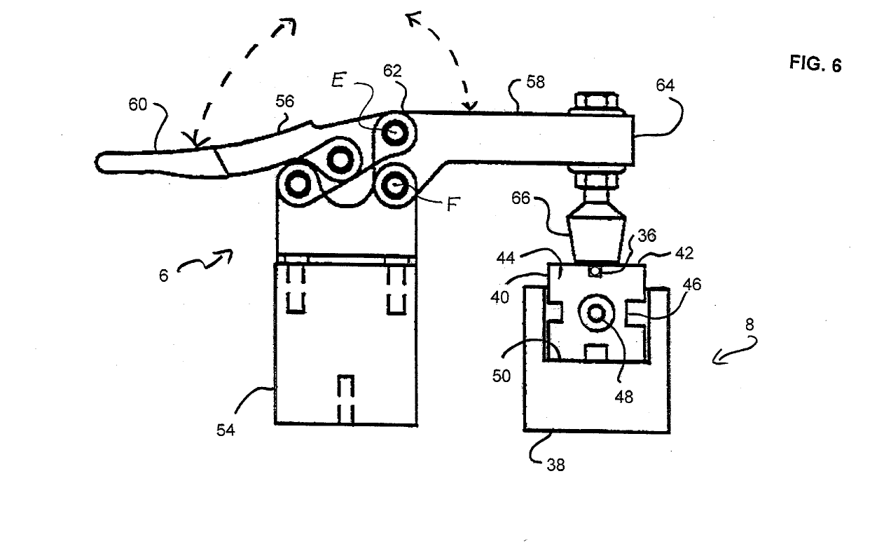

Turning to FIGS. 1, 5 and 6, a brief discussion concerning the clamp 6 will now be provided. The clamp 6 generally comprises a clamp base 54 which is directly mounted to the mounting plate 10, by one or more conventional fasteners, and fixedly supports a lever portion 56 and a tube securing arm 58. The tube securing arm 58 has a first end 62 and an opposed second end 64. The second end 64 of the tube securing arm 58 supports a tube engagement element 66. The lever portion 56 interconnects the first end 62 of the tube securing arm 58 with the clamp base 54 in a manner such that when the lever portion 56 pivots from the retracted position, shown in FIG. 5, into the extended and clamped position, shown in FIG. 6, the lever portion 56 exerts a prying force or motion to the first end 62 of the tube securing arm 58 and which thereby pivots the tube securing arm 58, about its pivot axis F, until the tube engagement element 66 engages with exterior surface of the tube 36 located within upwardly facing tube channel 46 that is coincident with the pusher axis A. The lever portion 56 has a hand grip 60 affixed thereto which permits an operator to grip and pivot the lever portion 56 about its pivot axis E and thereby cause the tube securing arm 58 to pivot from its retracted and loading position, shown in FIG. 5, into its extended and locked position, shown in FIG. 6, in which the tube engagement element 66 of the tube securing arm 58 applies desired clamping pressure to securely clamp the tube 36 within one of the tube channels 46 of the tube channel block 42, as shown in FIGS. 1 and 2.

The tube engagement element 66 preferably comprises a firm but pliable material, such as rubber, with a surface shaped so as to provide a secure engagement of the tube 36 when the clamp 6 is moved into its extended and locked position. In addition, preferably the tube engagement element 66 is threadedly connected to the free end of tube securing arm 58 so as to allow adjustment of the relative spacing between a leading surface of the tube engagement element 66 and the tube securing arm 58. When the tube securing arm 58 is in its extended and locked position, shown in FIG. 6, the tube engagement element 66 will securely clamp the tube 36 within the tube channel 46 so as to prevent relative motion between the tube 36 and the tube channel block 42 but not sufficiently distort the shape of the tube 36 so as to hinder insertion of the fitting 32 into the terminal end 34 of the tube 36.

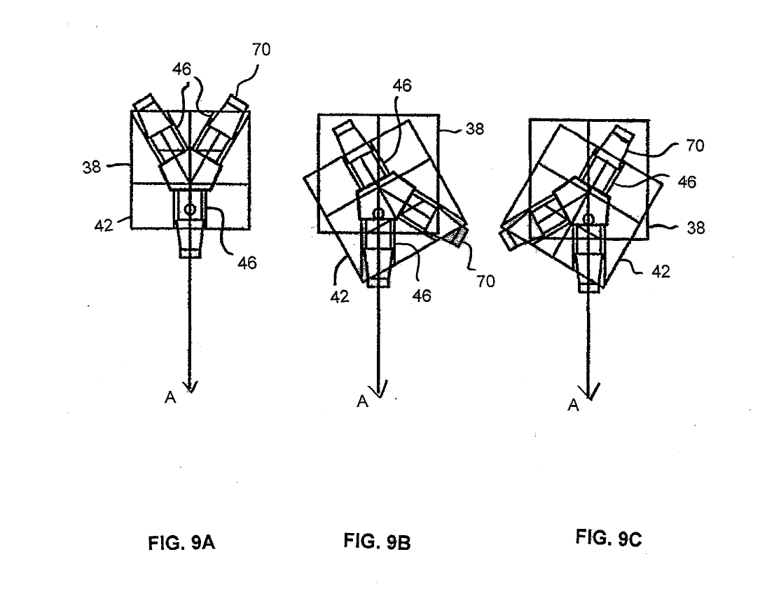

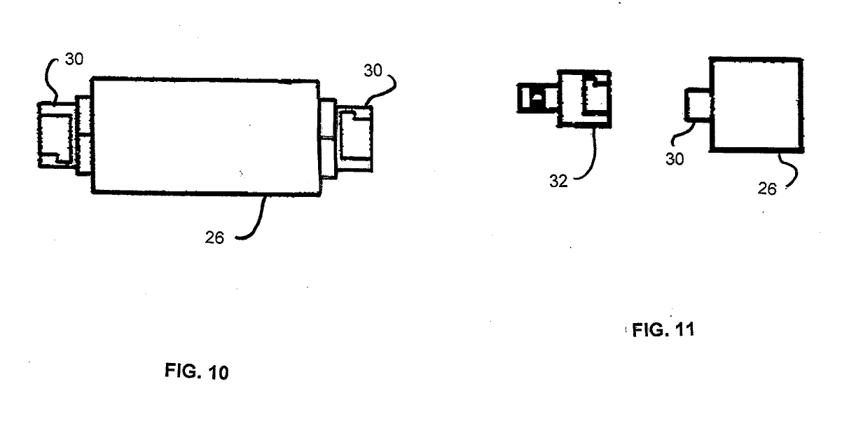

Turning to FIGS. 9A-9C, an alternative embodiment is shown wherein the tube channel block 42 may be designed to hold “Y” adapters or fitting 70. According to this embodiment, the tube channel block 42 has a single “Y” shaped channel 46 on a upper most surface 40, with that single channel 46 extending toward the opposite side and before splitting into two separate and diverging channels 46′, 46″. The tube channel block 42 is able to rotate or spin normal along a pivot axis which extends normal to both the pusher axis A and the clamp axis B such that each one of the three channels 46, 46′, 46″ can be sequentially aligned with and along the pusher axis A to allow a terminal end 34 of a tube 36 to be attached around the barbed section 33 of the “Y” adapters or fitting 70.

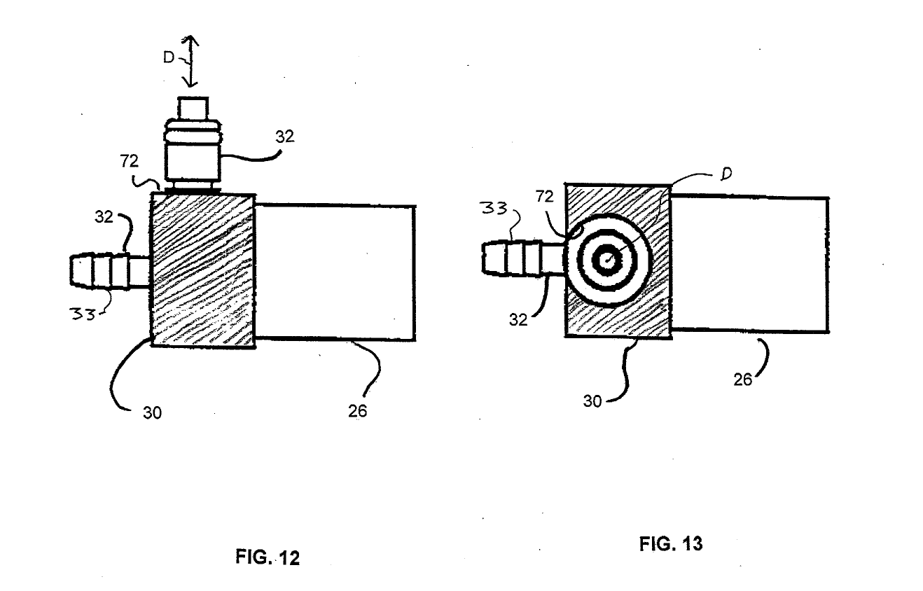

Turning now to FIGS. 12 and 13, an elbow fitting holder 26 for accommodating an elbow fitting 32 is shown therein. Because an elbow fitting 32 typically does not have a through bore with axially opposed openings, an alternative fitting holder design is necessary to accommodate such elbow fittings 32. According to this embodiment, instead of one end of the holder fitting onto an axial nub 30, the elbow fitting 32 slides downward along a slid axis D into a seating nub 72 located within the fitting holder 26. The seating nub 72 is a recessed channel of the enlarged nub 30, which wraps around the majority of the circumference of the elbow fitting 32 so as to provide proper alignment of the elbow fitting 32, while still allowing the fitting to be inserted into a terminal end 34 of a tube 36 when the pusher element 4 is extended to the position shown in FIGS. 1 and 4. Once the elbow fitting 32 is fully and completely engaged with the terminal end 34 of the tube 36, the clamp 6 is released and moved to the loading position, shown in FIG. 5, so that the tube 36 with the elbow fitting 32 just attached thereto may be lifted and removed from the seating nub 72 by lifting and moving the elbow fitting 32 along the slide axis D. Once the elbow fitting 32 is completely removed from the seating nub 72, then the pusher element 4 is retracted (i.e., moved into the retracted position shown in FIGS. 2 and 3) where it may be again loaded with another elbow fitting 32 so that the above process can be repeated.

It is to be appreciated that the shape of the fixing seating 72, although shown as being generally cylindrical in shape, may vary from application to application depending upon the overall exterior shape or profile of the elbow fitting 32. For example, the seating nub 72 could be a generally rectangular or square recess, a generally hexagonal shaped recess, or any other desired shape recess which is suitable for accommodating the desired elbow fitting 32 to be coupled to the tube 36.

In an alternative embodiment, the pusher element 4 may be securely bordered by two parallel raised walls, one on either side of the pusher element 4, with both walls extending parallel with the pusher axis A. The walls, raising from the base plate 10, will physically limit the amount that the pusher element many deviate from the pusher axis A, and thus ensure direct horizontal alignment.

In another alternative embodiment, the pusher element 4 could be mounted to a lockable guide block and rails (not shown), and the rails could be mounted on the mounting plate 10. The guide block and rails would preserve desired movement of the pusher element 4 and would help insure axial alignment of the pusher element 4 and therefore the fitting 32 with the terminal end 34 of the tube 36.

In some applications, a ruler or some other measurement device 68 may be attached or secured on the top surface of the mounting plate 10 and extend parallel to the pusher axis A alongside the pusher element 4. This device 68 allows a quick and accurate reference of the relative position and placement of the tube 36 relative to the fitting holder 26.

To operate the tube fitting insertion tool 2, first the proper sized fitting holder 26, for supporting the desired fitting 32 is selected and suitably positioned within the concave cavity 28 of the holder seat 24 of the pusher element 4 (if not already attached thereto). Next, the proper sized tube holder block 42 is attached to the tube holder base 38 and rotated to expose the proper sized tube channel 46 (if necessary), the pusher element 4 is arranged in its retracted position (if not already so retracted) and the clamp 6 is arranged in its loading position (if not already in such position).

Next, a desired fitting 32 is placed onto the nub 30 of the fitting holder 26 and the desired tube 36 is placed into a channel 46 of the tube holder 8, with a terminal end 34 of the tube 36 extending a desired distance past and out of the tube channel block 42, e.g., that is the tube 36 extends past the tube channel block 42 by a distance of between about one half of an inch to about one and ¼ inches or so, depending upon the length of the barbed section 33 of the fitting 32. That is, the tube 36 extends out from the tube channel block 42 by a sufficient distance such that the barbed section 33 of the fitting 32 can be completely inserted into the terminal end of the tube 36 without the leading barbed section 33 of the fitting 32 engaging with the section of the tube 36 being clamped by the clamp 6. Once the tube 36 is properly located on the tube channel block 42, the clamp handle 60 is rotated or pivoted to its closed and locked position (see FIG. 6). The pusher element handle 16 is then pivoted or rotated toward the clamp 6 thereby moving the pusher element 4, including the shaft 18, the fitting holder 26 and the supported fitting 32, from a retracted position into the extended position, and thereby moving the fitting 32 along the pusher axis A toward and into the terminal end 34 of the tube 36 until the fitting 32 is completely received and seated within the terminal and 34 of the tube 36. Once this occurs, the barbs of the fitting 32 facilitate retaining the engagement therebetween and frictionally prevents the terminal end 34 of the tube 36 from becoming disengaged from the just installed fitting 32.

The pusher element handle 16 is then pivoted or rotated in an opposite direction away from the clamp 6 so as to move the shaft 18 and the fitting holder 26 in an opposite direction along the pusher axis A thereby separating the fitting 32 from the nub 30 and leaving the fitting 32 captively engaged with and retained by the terminal end 34 of the tube 36. The clamp handle 60 is then pivoted or rotated from the locked position into the loading position so as to disengage the clamp 6 from the tube 36 thereby release the tube 36. The tube 36, with the fitting 32 frictionally retained therein, may then be removed from the tube channel block 42, and this process can then be repeated again to install another fitting 32 onto the terminal end 34 of another tube 36.

Since certain changes may be made in the above described tube fitting insertion tool, without departing from the spirit and scope of the invention herein involved, it is intended that all of the subject matter of the above description and/or shown in the accompanying drawings shall be interpreted merely as examples illustrating the inventive concept herein and shall not be construed as limiting the invention. Moreover, in the above description and appended drawings and claims, it is to be appreciated that only the terms “consisting of” and “consisting only of” are to be construed in the limitative sense while of all other terms are to be construed as being open-ended and given the broadest possible meaning.

Wherefore, I claim:

1. A tube fitting insertion tool comprising:
a mounting plate;
a pusher element attached to the mounting plate, and the pusher element releasably supporting a fitting and defining a pusher axis;
a clamp attached to the mounting plate and defining a clamp axis;
a tube holder, arranged at the intersection of the pusher and clamp axes, with at least one tube channel for supporting a portion of a tube, and the clamp being pivotable toward the tube holder for clamping the tube to the tube holder.

2. The tube fitting insertion tool of claim 1, wherein the pusher element supports a fitting holder and the fitting is supported by a nub of fitting holder.

3. The tube fitting insertion tool of claim 2, wherein the fitting holder is slidably retained within a cavity formed within a holder seat of the fitting holder.

4. The tube fitting insertion tool of claim 2, wherein the fitting holder supports one of a strait barb fitting, an elbow fitting, and a hexagonal fitting.

5. The tube fitting insertion tool of claim 2, wherein the nub of the fitting holder is a male component which is between 1 to 5 thousandths of an inch smaller than an interior diameter of a through bore of the fitting to be supported by the nub.

6. The tube fitting insertion tool of claim 2, wherein the fitting holder has a pair of nubs located at opposing ends of the fitting holder.

7. The tube fitting insertion tool of claim 1, wherein the tube holder comprises a non rotatable tube holder base and a lockably rotatable tube channel block.

8. The tube fitting insertion tool of claim 7, wherein the tube channel block has at least one tube channel along at least one exterior surface formed such that when a tube of a predetermined size is placed in the tube channel, a center of the tube will align with the pusher axis.

9. The tube fitting insertion tool of claim 7, wherein the tube channel block is a shaped generally as a rectangular prism, with at least one tube channel along each of four exterior surfaces of the tube channel block.

10. The tube fitting insertion tool of claim 9, wherein the at least one tube channels are each of different widths.

11. The tube fitting insertion tool of claim 8, wherein the tube channel block is shaped as one of a hexagonal and octagonal prism.

12. The tube fitting insertion tool of claim 7, wherein the tube channel block is partially seated within a concave portion of the tube holder base.

13. The tube fitting insertion tool of claim 12, wherein the tube channel block is spring biassed to sit in the concave portion of the tube holder base, and when the tube channel block is moved a predetermined distance in a direction opposite the direction of the spring bias, the tube channel block may be freely rotated about a center mounting.

14. The tube fitting insertion tool of claim 13, wherein the center mounting defines a mounting axis that is parallel with the pusher axis.

15. The tube fitting insertion tool of claim 7, wherein the at least one tube channel is between 70% and 90% the width of the exterior diameter of a tube placed within it.

16. The tube fitting insertion tool of claim 7, wherein the tube channel block is formed with a Y shaped channel.

17. The tube fitting insertion tool of claim 1 wherein the tool formed at least partially out of aluminum, an alloy of aluminum, or PVC.

18. The tube fitting insertion tool of claim 1, wherein the pusher axis and the clamp axis are substantially perpendicular.

19. A method of inserting a fitting on a terminal end of a tube, the steps comprising:
providing a tube insertion tool comprising a mounting plate, a pusher element attached to the mounting plate, supporting a fitting holder and defining a pusher axis, a clamp attached to the mounting plate and defining a clamp axis, and a tube holder, arranged at the intersection of the pusher and clamp axis, with at least one tube channel for supporting a portion of a tube
inserting and securing a fitting holder into a concave cavity within a holder seat of the pusher element;
exposing a tube channel on a tube channel block of the tube holder;
retracting the pusher element;
moving the clamp to a loading position;
attaching a fitting onto a nub of the fitting holder;
placing a tube into the tube channel, with a terminal end of the tube extending past the tube channel block a predetermined distance;
pressing down a clamp handle and moving the clamp to a closed locked position;
pulling forward a pusher element handle and moving a pusher element shaft and the fitting holder from a retracted position to an extended position;
moving the fitting along an axis defined by the shaft, toward the terminal end of the tube, until the fitting is fully engaged with and frictionally retained by the terminal end of the tube.
pulling the pusher element handle in an opposite backward direction and thereby moving the shaft and the fitting holder in the same an opposite direction;
leaving the fitting captively engaged with and retained by the terminal end of the tube;
pulling the clamp handle upward, disengaging the clamp from the closed locked position,
raising a clamp stopper off of and releasing the tube and putting the clamp in an at least partially loading position.

20. A tube fitting insertion tool comprising
a mounting plate
a pusher element attached to the mounting plate and defining a pusher axis; and including a holder seat,
a clamp attached to the mounting plate and defining a clamp axis that is substantially perpendicular to the pusher axis; and
a tube holder, arranged at the intersection of the pusher and clamp axis, and including a non rotatable tube holder base and a lockably rotatable tube channel block;
a fitting holder slidably realisably retained at least partially within a concave portion of the holder seat;
at least one nub on a portion of the fitting holder not within the concave portion of the holder seat,
a fitting supported by the at least one nub;
the fitting holder being adapted to support one of a strait barb fitting, an elbow fitting, and a hexagonal fitting;
the at least one nub having one of a male connection between 1 and 5 thousandths of an inch smaller than a an interior diameter of the fitting, and a female connection between 1 and 5 thousands of an of an inch larger than an exterior diameter of the fitting;
the tube channel block being shaped generally as a rectangular prism, with at least one tube channel along at least 4 exterior surfaces, each tube channel being a different width;
the tube channels formed such that when a tube of a predetermined size is placed in the tube channel, a center of the tube will align with the pusher axis;
the tube channel block being further partially seated within a concave portion of the tube holder base, and spring biassed to sit in the concave portion of the tube holder base, such that when the tube channel block is moved a predetermined distance in a direction opposite the direction of the spring bias, the tube channel block may be freely rotated about a center mounting that defines a mounting axis that is parallel with the pusher axis; and
the tube fitting insertion tool being formed at least partially out of aluminum, an alloy of aluminum, or PVC.
